(19) United States
(12) Patent Application Publication
(10) Pub. No.: US 2018/0068330 A1
(43) Pub. Date: Mar. 8, 2018

(54) Deep Learning Based Unsupervised Event Learning for Economic Indicator Predictions

(71) Applicant: International Business Machines Corporation, Armonk, NY (US)

(72) Inventors: Abhirut Gupta, Bangalore (IN); Rahul D. Sharnagat, Bangalore (IN); Srikanth G. Tamilselvam, Bangalore (IN)

(21) Appl. No.: 15/258,176

(22) Filed: Sep. 7, 2016

(51) Int. Cl. G06Q 30/02

(52) U.S. Cl. CPC G06Q 30/0202; G06Q 30/0201

(57) ABSTRACT

Methods, systems, and computer program products for deep learning based unsupervised event learning for economic indicator predictions are provided herein. A computer-implemented method includes extracting multiple events from a collection of documents; determining characteristics of the extracted events, wherein the characteristics comprise (i) one or more actions occurring within each event, (ii) one or more actors participating in each event, and (iii) one or more objects affected by each event; deriving structured data, related to an economic indicator value to be predicted, from multiple data sources; combining items of the derived structured data into one or more groups based on (i) semantic similarity of the items and (ii) a temporal aspect attributed to each of the items; and generating a prediction for the economic indicator value based on a comparison of the one or more groups to the characteristics of each of the extracted events.

### FIELD

The present application generally relates to information technology, and, more particularly, to event learning techniques.

### BACKGROUND

Various types of news events, derived from a wide variety of global geographic locations, can influence financial markets significantly. However, existing approaches for event-driven financial market prediction fail to model an open set of events, and also fail to combine information from various events.

### SUMMARY

In one embodiment of the present invention, techniques for deep learning based unsupervised event learning for economic indicator predictions are provided. An exemplary computer-implemented method can include steps of extracting multiple events from a collection of documents; determining characteristics of the extracted events, wherein the characteristics comprise (i) one or more actions occurring within each of the extracted events, (ii) one or more actors participating in each of the extracted events, and (iii) one or more objects affected by each of the extracted events; deriving structured data, related to an economic indicator value to be predicted, from multiple data sources; combining items of the derived structured data into one or more groups based on (i) semantic similarity of the items and (ii) a temporal aspect attributed to each of the items; and generating a prediction for the economic indicator value based on a comparison of the one or more groups to the characteristics of each of the extracted events.

In another embodiment of the invention, an exemplary computer-implemented method can include identifying descriptions of multiple historic events from a collection of documents, measuring the impact of each of the events on an economic indicator value, and determining characteristics of the identified event descriptions, wherein the characteristics comprise (i) one or more actions occurring within each of the events, (ii) one or more actors participating in each of the events, and (iii) one or more objects affected by each of the events. Such a method can also include deriving structured data, related to the economic indicator value, from multiple news descriptions, and combining items of the derived structured data into multiple groups based on (i) semantic similarity of the items and (ii) publication date of the items. Further, such a method can include generating a prediction for the economic indicator value based on a comparison of the multiple groups to the characteristics of each of the identified event descriptions.

Another embodiment of the invention or elements thereof can be implemented in the form of an article of manufacture tangibly embodying computer readable instructions which, when implemented, cause a computer to carry out a plurality of method steps, as described herein. Furthermore, another embodiment of the invention or elements thereof can be implemented in the form of an apparatus including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an exemplary embodiment of the invention;

FIG. 2 is a diagram illustrating learning event embedding, according to an exemplary embodiment of the invention;

FIG. 3 is a flow diagram illustrating techniques, according to an embodiment of the invention;

FIG. 4 is a system diagram of an exemplary computer system on which at least one embodiment of the invention can be implemented;

FIG. 5 depicts a cloud computing environment, according to an embodiment of the present invention; and

FIG. 6 depicts abstraction model layers, according to an embodiment of the present invention.

### DETAILED DESCRIPTION

As described herein, an embodiment of the present invention includes techniques for deep learning based unsupervised event learning for economic indicator predictions. At least one embodiment of the invention includes predicting one or more economic indicators using a sequence of events, wherein the prediction is made using a long short term memory (LSTM) model to combine the events in the sequence for a given time window. An LSTM model is a type of recurrent neural network which can learn from experience to classify, process and predict time series when there are time lags of unknown size between important events.

Additionally, one or more embodiments of the invention can include incorporating time into an event embedding, wherein the events which occur closer together in time have closer vectors than events which occur farther apart in time. An event embedding, also referred to herein as an event vector, can include a vector space representation for an event wherein events which are similar and occur closer in time have vectors which are closer than events which are not similar and/or occur at different times.

As used herein, an event refers to an action and the objects affected thereby. As described herein, “objects” can include entities, people, organizations, etc. Additionally, at least one embodiment of the invention includes modeling an open set of events. Also, an event can be represented, for example, in multiple forms via various sources of news. Economic indicators such as, for example, stock prices, can respond to a single event, as well as to a series of events within a given period of time. As such, at least one embodiment of the invention can include representing such series of events, and using the representation to measure impact on economic indicators.

In one or more embodiments of the invention, an LSTM model is utilized to combine the sequence or series of events for a given time window. For example, the events can be combined into one or more groups based on semantic similarity and publication date. Further, at least one embodiment of the invention can include modeling an open set of events based on the groups and/or combinations of events. An event can be modeled as a vector, and a sequence of events in the given time window can be modeled as a vector that combines this information using an LSTM model.

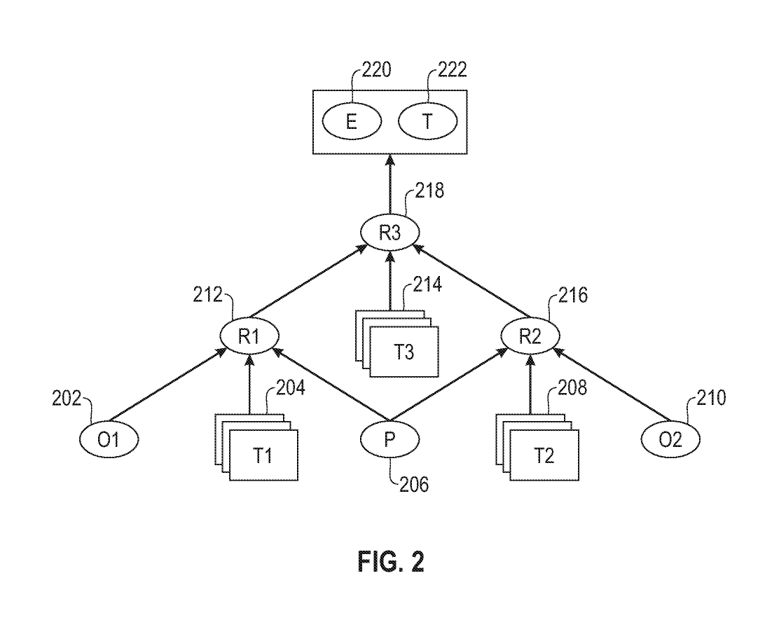

One or more embodiments of the invention can also include incorporating a temporal aspect into the event embedding. The time at which an event instance occurs can be deemed important information, and, in at least one embodiment of the invention, events which occur closer together in time will have closer vectors than events which are less temporally proximate. Because there can be multiple mentions of the same event in different sources, similar vectors (which implies similar actors, a similar action, and a similar time) can be grouped together into a joint vector for the event. As detailed further herein, FIG. 2 includes a depiction of how a vector (or event embedding) is generated. As described above, such a vector can contain information about the event itself (subject, object, and predicate) and an additional dimension for time. The ultimate role of such a vector is to help combine information from events and use this information to model the change in economic indicators.

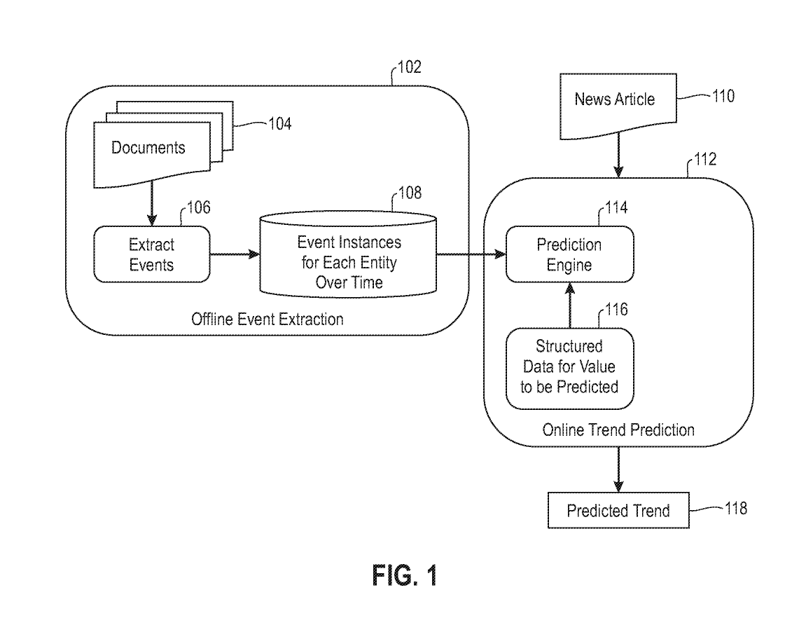

FIG. 1 is a diagram illustrating system architecture, according to an embodiment of the invention. By way of illustration, FIG. 1 depicts an offline event extraction component 102, which includes an event extraction module 106 extracting events from a collection of documents 104. Additionally, within the offline event extraction component 102, module 106 outputs all extracted event instances for each of one or more entities over one or more given periods of time to a database 108. As also depicted, FIG. 1 includes an online trend prediction component 112, which derives structured data 116 for value predictions (such as a stock price prediction) from a news article 110. Such data 116 are provided, along with event instances stored in database 108, to a prediction engine 114 (resident within the online trend prediction component 112). Based on such inputs, the prediction engine 114 generates and outputs a predicted trend 118. The vectors (event embeddings) can be used via the prediction engine 114, in which event embeddings can be combined for a sequence of events using an LSTM model, and in which the combination can be used to model an economic indicator.

FIG. 2 is a diagram illustrating learning event embedding, according to an exemplary embodiment of the invention. In FIG. 2, T1 (204), T2 (208), and T3 (214) represent tensors which are used to combine the representations for objects O1 (202) and O2 (210), and predicate P (206) into an intermediate representation in the neural network. Further, objects O1 (202) and O2 (210), and predicate P (206) can be extracted from a natural language sentence (a sentence from news article, for example).

At least one embodiment of the invention can include employing a neural tensor network (as depicted via FIG. 2) to combine the representation of objects (R1 212, R2 216, and R3 218) and the predicate 206 with tensor (T3) 214 to generate an event embedding (E) 220. Additionally, a tensor (T) 222 can be appended to the generated event embedding 220.

By way of further illustration of one or more embodiments of the invention, consider the following example use case scenario. Consider three events, E1, E2, E3, all of which have a similar subject, a similar object, and similar predicates. E1 and E2 are temporally proximate, while E3 occurs at a time that is not proximate to E1 or E2. Accordingly, vector representations of E1, E2, and E3 can encode relevant information (including information about the entities (O1, O2), the predicate in the event, and temporal information about the event) and ensure that the vectors for E1 and E2 are similar to each other, but not similar to the vector for E3. To accomplish this, one or more embodiments of the invention can include adding an axis to the vector space which represents time. The value for such an axis can include, for example, the time elapsed since some given point in time. This would ensure that vectors of events with similar actors and predicates, but occurring at significantly different times, would be dissimilar from each other (as compared to vectors of events with similar actors, predicates, and temporal occurrences).

Additionally, as noted herein, at least one embodiment of the invention can include implementing an LSTM model. An LSTM network can be utilized to classify, process and predict time series when significant time lags of unknown size occur between important events. For example, an LSTM model can be composed of blocks that can remember and/or maintain a value for an arbitrary or pre-determined amount of time. Further, such an LSTM model can contain gates that determine if a value is significant enough to be remembered, as well as when to forget such a value and when to output such a value.

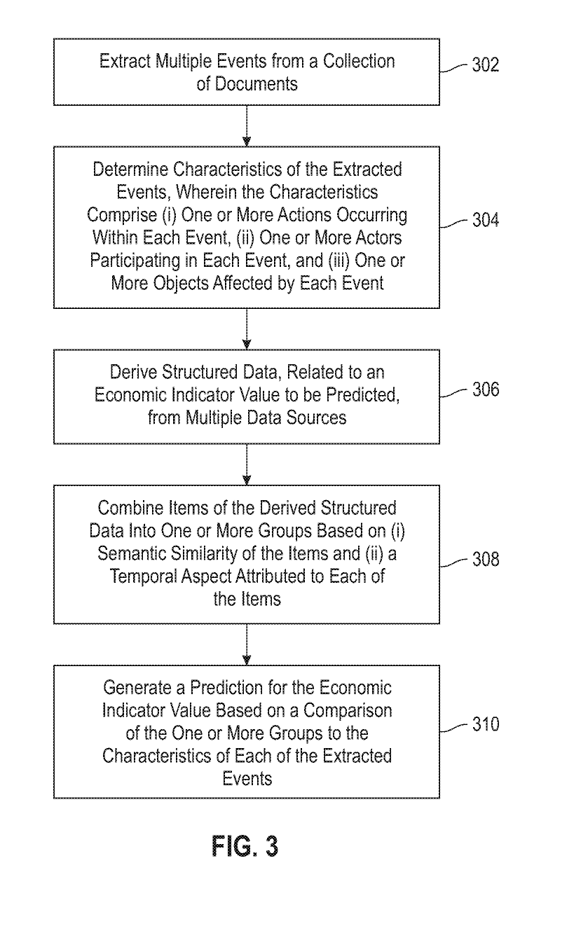

FIG. 3 is a flow diagram illustrating techniques according to an embodiment of the present invention. Step 302 includes extracting multiple events from a collection of documents. At least one embodiment of the invention can also include measuring the impact of each of the events on the economic indicator value.

Step 304 includes determining characteristics of the extracted events, wherein the characteristics comprise (i) one or more actions occurring within each of the extracted events, (ii) one or more actors participating in each of the extracted events, and (iii) one or more objects affected by each of the extracted events. Step 306 includes deriving structured data, related to an economic indicator value to be predicted, from multiple data sources. The data sources can include, for example, one or more news descriptions. Also, the value to be predicted can include the price of a financial asset (such as, for example, the price of a stock).

Step 308 includes combining items of the derived structured data into one or more groups based on (i) semantic similarity of the items and (ii) a temporal aspect attributed to each of the items. Step 310 includes generating a prediction for the economic indicator value based on a comparison of the one or more groups to the characteristics of each of the extracted events. The temporal aspect can include an occurrence time attributed to each item in the derived structured data and/or the amount of time elapsed since a predetermined point in time.

The techniques depicted in FIG. 3 can also include storing the extracted events for one or more given periods of time in a database. Further, one or more embodiments of the invention can include outputting the generated prediction to at least one user. Also, in at least one embodiment of the invention carried out in accordance with the techniques of FIG. 3, software is provided as a service in a cloud environment.

Additionally, the techniques depicted in FIG. 3 can include representing the derived structured data as vectors by incorporating the temporal aspect attributed to each item in the derived structured data, wherein such representing can include positioning the vectors, relative to each other, based on the proximity of the temporal aspect attributed to each item in the derived structured data. At least one embodiment of the invention can also include measuring the impact of each of the vectors on the economic indicator.

Also, an additional embodiment of the invention includes identifying descriptions of multiple historic events from a collection of documents, measuring the impact of each of the events on an economic indicator value, and determining characteristics of the identified event descriptions, wherein the characteristics comprise (i) one or more actions occurring within each of the events, (ii) one or more actors participating in each of the events, and (iii) one or more objects affected by each of the events. Such an embodiment can also include deriving structured data, related to the economic indicator value, from multiple news descriptions, and combining items of the derived structured data into multiple groups based on (i) semantic similarity of the items and (ii) publication date of the items. Further, such an embodiment can include generating a prediction for the economic indicator value based on a comparison of the multiple groups to the characteristics of each of the identified event descriptions. Additionally, in such an embodiment, combining the items of the derived structured data into multiple groups can include implementing a long short term memory model, wherein the long short term memory model can include a set of blocks that maintain a value for a pre-determined amount of time, as well as a threshold that determines whether a value is to be maintained.

At least one embodiment of the invention (such as the techniques depicted in FIG. 3, for example), can include implementing a service via a transmission server to receive data from a data source and send selected data to users (for example, at a provided destination address of a wireless device (such as a number for a cellular phone, etc.)). The transmission server includes a memory, a transmitter, and a microprocessor. Such an embodiment of the invention can also include providing a viewer application to the users for installation on their individual devices. Additionally, in such an embodiment of the invention, after a user enrolls, the service receives news and/or event information sent from a data source to the transmission server. The server can process the information, for example, based upon user-provided user preference information that is stored in memory on the server. Subsequently, an alert is generated containing a trend prediction. The alert can be formatted into data blocks, for example, based upon any provided alert format preference information. Subsequently, the alert and/or formatted data blocks are transmitted over a data channel to the user's wireless device. After receiving the alert, the user can connect the wireless device to the user's computer, whereby the alert causes the user's computer to automatically launch the application provided by the service to display the alert. When connected to the Internet, the user may then use the viewer application (for example, via clicking on a URL associated with the data source provided in the alert) to facilitate a connection from the remote user computer to the data source over the Internet for additional information.

The techniques depicted in FIG. 3 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

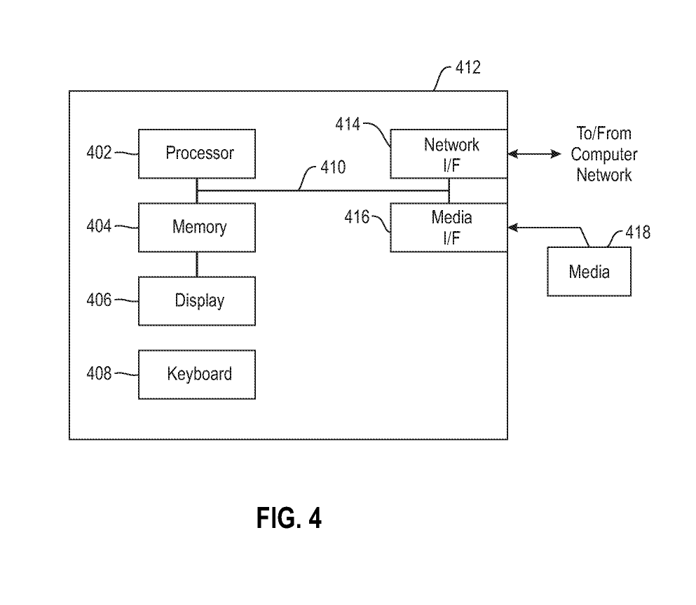

Additionally, an embodiment of the present invention can make use of software running on a computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 402. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

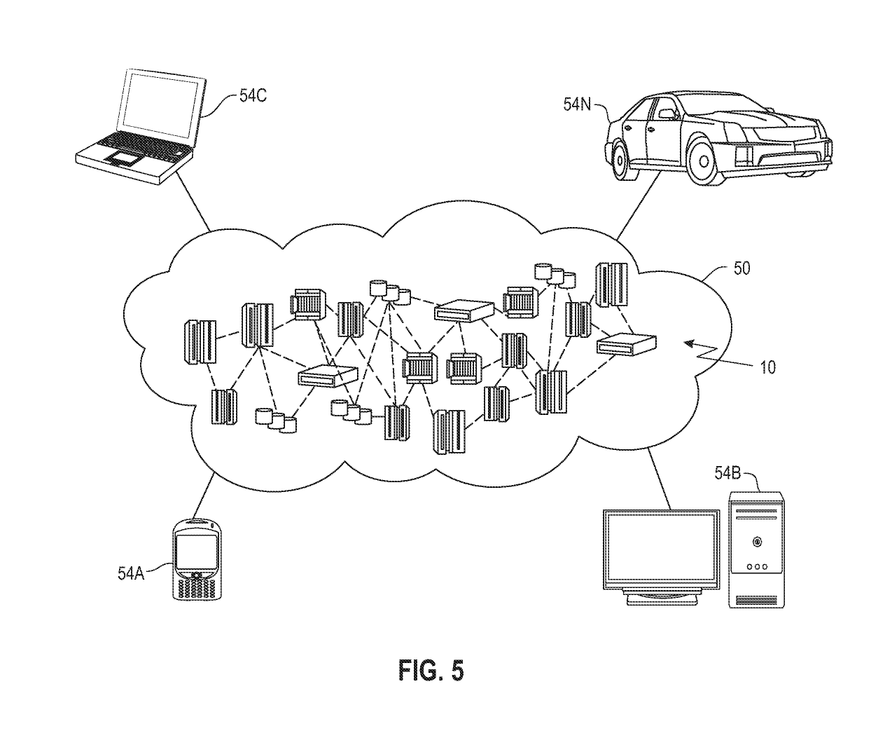

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

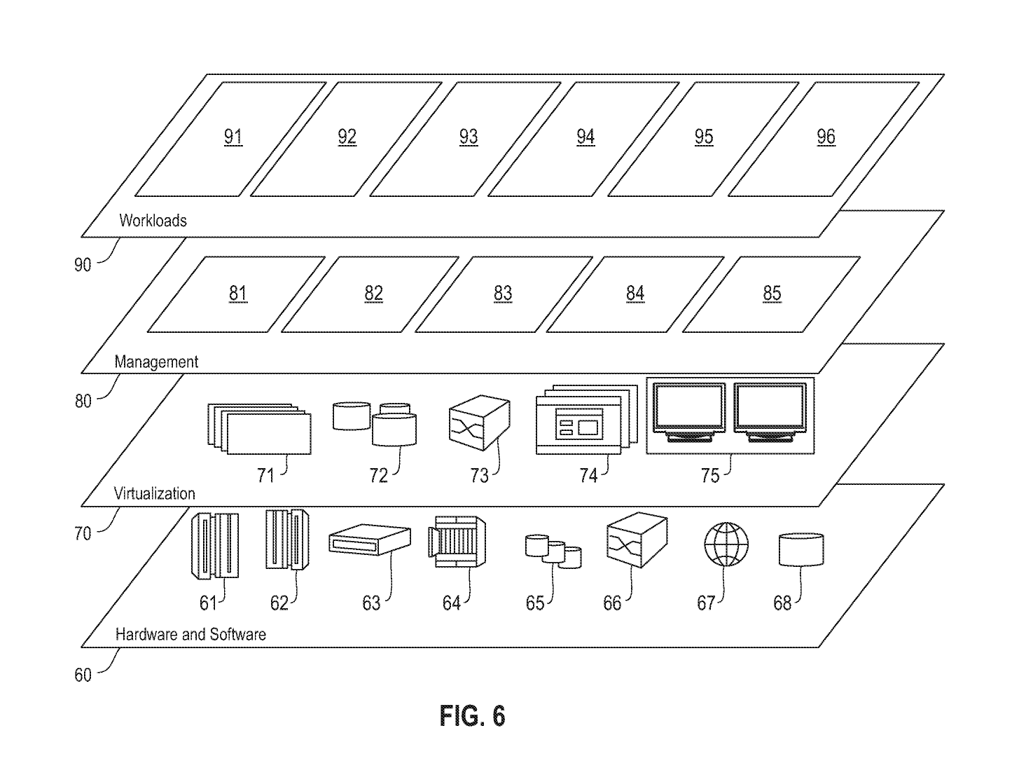

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and economic indicator prediction generation 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, predicting economic indicators using an LSTM model to combine a sequence of events in a given time window.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
extracting multiple events from a collection of documents;
determining characteristics of the extracted events, wherein the characteristics comprise (i) one or more actions occurring within each of the extracted events, (ii) one or more actors participating in each of the extracted events, and (iii) one or more objects affected by each of the extracted events;
deriving structured data, related to an economic indicator value to be predicted, from multiple data sources;
combining items of the derived structured data into one or more groups based on (i) semantic similarity of the items and (ii) a temporal aspect attributed to each of the items; and
generating a prediction for the economic indicator value based on a comparison of the one or more groups to the characteristics of each of the extracted events;
wherein the steps are carried out by at least one computing device.

2. The computer-implemented method of claim 1, comprising:
measuring the impact of each of the events on the economic indicator value.

3. The computer-implemented method of claim 1, wherein the one or more data sources comprise one or more news descriptions.

4. The computer-implemented method of claim 1, wherein the value to be predicted comprises the price of a financial asset.

5. The computer-implemented method of claim 1, wherein the temporal aspect comprises an occurrence time attributed to each item in the derived structured data.

6. The computer-implemented method of claim 1, wherein the temporal aspect comprises the amount of time elapsed since a predetermined point in time.

7. The computer-implemented method of claim 1, comprising:
storing the extracted events for one or more given periods of time in a database.

8. The computer-implemented method of claim 1, comprising:
outputting the generated prediction to at least one user.

9. The computer-implemented method of claim 1, comprising:
representing the derived structured data as vectors by incorporating the temporal aspect attributed to each item in the derived structured data.

10. The computer-implemented method of claim 9, wherein said representing comprises positioning the vectors, relative to each other, based on the proximity of the temporal aspect attributed to each item in the derived structured data.

11. A computer program product comprising a computer readable storage medium having program instructions embodied therewith, the program instructions executable by a device to cause the device to:
extract multiple events from a collection of documents;
determine characteristics of the extracted events, wherein the characteristics comprise (i) one or more actions occurring within each of the extracted events, (ii) one or more actors participating in each of the extracted events, and (iii) one or more objects affected by each of the extracted events;
derive structured data, related to an economic indicator value to be predicted, from multiple data sources;
combine items of the derived structured data into one or more groups based on (i) semantic similarity of the items and (ii) a temporal aspect attributed to each of the items; and
generate a prediction for the economic indicator value based on a comparison of the one or more groups to the characteristics of each of the extracted events.

12. The computer program product of claim 11, wherein the program instructions executable by a computing device further cause the computing device to:
output the generated prediction to at least one user.

13. The computer program product of claim 11, wherein the program instructions executable by a computing device further cause the computing device to:
measure the impact of each of the events on the economic indicator value.

14. The computer program product of claim 11, wherein the program instructions executable by a computing device further cause the computing device to:
represent the derived structured data as vectors by incorporating the temporal aspect attributed to each item in the derived structured data.

15. A system comprising:
a memory; and
at least one processor coupled to the memory and configured for:
extracting multiple events from a collection of documents;
determining characteristics of the extracted events, wherein the characteristics comprise (i) one or more actions occurring within each of the extracted events, (ii) one or more actors participating in each of the extracted events, and (iii) one or more objects affected by each of the extracted events;
deriving structured data, related to an economic indicator value to be predicted, from multiple data sources;
combining items of the derived structured data into one or more groups based on (i) semantic similarity of the items and (ii) a temporal aspect attributed to each of the items; and
generating a prediction for the economic indicator value based on a comparison of the one or more groups to the characteristics of each of the extracted events.

16. The system of claim 15, wherein the at least one processor is further configured for:
outputting the generated prediction to at least one user.

17. A computer-implemented method, comprising:
identifying descriptions of multiple historic events from a collection of documents;
measuring the impact of each of the events on an economic indicator value;
determining characteristics of the identified event descriptions, wherein the characteristics comprise (i) one or more actions occurring within each of the events, (ii) one or more actors participating in each of the events, and (iii) one or more objects affected by each of the events;
deriving structured data, related to the economic indicator value, from multiple news descriptions;
combining items of the derived structured data into multiple groups based on (i) semantic similarity of the items and (ii) publication date of the items; and
generating a prediction for the economic indicator value based on a comparison of the multiple groups to the characteristics of each of the identified event descriptions;
wherein the steps are carried out by at least one computing device.

18. The computer-implemented method of claim 17, wherein said combining the items of the derived structured data into multiple groups comprises implementing a long short term memory model.

19. The computer-implemented method of claim 18, wherein the long short term memory model comprises a set of blocks that maintain a value for a pre-determined amount of time.

20. The computer-implemented method of claim 18, wherein the long short term memory model comprises a threshold that determines whether a value is to be maintained.
